(19) United States
(12) Patent Application Publication
(10) Pub. No.: US 2024/0391304 A1
(43) Pub. Date: Nov. 28, 2024

(54) VEHICLE SLIDE DOOR DEVICE

(71) Applicant: AISIN CORPORATION, Kariya (JP)

(72) Inventor: Kazuo KOJIMA, Kariya-shi (JP)

(73) Assignee: AISIN CORPORATION, Kariya (JP)

(21) Appl. No.: 18/641,514

(22) Filed: Apr. 22, 2024

(30) Foreign Application Priority Data
May 24, 2023 (JP) 2023-085559

(51) Int. Cl. B60J 5/06

(52) U.S. Cl. CPC B60J 5/06

(57) ABSTRACT

A vehicle slide door device includes a drive belt configured to drive a slide door of a vehicle to open and close, first and second pulleys around which the drive belt is wound, and a guide frame that supports the first and second pulleys at positions separated from each other and has a guide path for the drive belt extending between support positions of the first and second pulleys. The guide frame includes a first frame member that supports the first pulley, a second frame member that supports the second pulley, and a pivot coupling portion that is provided between the first frame member and the second frame member and couples the first and second frame members in such a manner that the first frame member and the second frame member are pivotable relative to each other.

### CROSS REFERENCE TO RELATED APPLICATIONS

This application is based on and claims priority under 35 U.S.C. § 119 to Japanese Patent Application 2023-085559, filed on May 24, 2023, the entire content of which is incorporated herein by reference.

### TECHNICAL FIELD

This disclosure relates to a vehicle slide door device.

### BACKGROUND DISCUSSION

In the related art, there is a vehicle slide door device that opens and closes a slide door of a vehicle using a drive belt. For example, a slide door device disclosed in JP 2019-100081A (Reference 1) includes an annular drive belt and first and second pulleys around which the drive belt is wound. Further, the slide door device includes a guide frame that supports the first and second pulleys and has a drive belt guide path extending between support positions of the first and second pulleys. The drive belt wound around the first and second pulleys is driven to rotate in a state of being guided by the guide frame.

The slide door device in the related art includes the guide frame divided into two in a longitudinal direction. Further, when the guide frame is assembled to the vehicle, first and second guide members obtained by dividing the guide frame into two are coupled to a vehicle body via a mounting seat. Accordingly, the ease of assembly to the vehicle body can be improved.

In general, such a guide frame is disposed in a groove-shaped accommodation recessed portion provided in a side surface of the vehicle body together with a guide rail for guiding an opening and closing operation of the slide door. For example, a so-called “hidden structure” using a cover member or the like is formed to cover an outer side of the guide frame disposed inside the accommodation recessed portion.

However, in most cases, the guide frame as described above has a corner portion curved in a vehicle width direction so that the slide door does not interfere with the vehicle body when the slide door is opened and closed. Therefore, in consideration of the “hidden structure” as described above, an assembling procedure is restricted. That is, even when the guide frame is assembled, from an opening portion on a vehicle front side or a vehicle rear side, to the accommodation recessed portion in a state where an outer side in the vehicle width direction is covered by the “hidden structure”, there is a problem in that the corner portion is likely to interfere with the vehicle body or the hidden structure.

### SUMMARY

According to an aspect of this disclosure, a vehicle slide door device includes a drive belt configured to drive a slide door of a vehicle to open and close, first and second pulleys around which the drive belt is wound, and a guide frame that supports the first and second pulleys at positions separated from each other and has a guide path for the drive belt extending between support positions of the first and second pulleys. The guide frame includes a first frame member that supports the first pulley, a second frame member that supports the second pulley, and a pivot coupling portion that is provided between the first frame member and the second frame member and couples the first and second frame members in such a manner that the first and second frame members are pivotable relative to each other.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view illustrating a vehicle provided with a slide door device;

FIG. 2 is a perspective view illustrating the slide door device;

FIG. 3 is an exploded perspective view illustrating the slide door device;

FIG. 4 is a plan view illustrating the slide door device;

FIG. 5 is a side view illustrating a guide frame;

FIG. 6 is a perspective view illustrating the guide frame in a first coupling state;

FIG. 7 is a plan view illustrating the guide frame in the first coupling state;

FIG. 8 is a perspective view illustrating the guide frame in a second coupling state;

FIG. 9 is a plan view illustrating the guide frame in the second coupling state;

FIG. 10 is a perspective view illustrating the vicinity of a pivot coupling portion;

FIG. 11 is a view illustrating an interference possibility during assembly;

FIG. 12 is a plan view illustrating the vicinity of the pivot coupling portion;

FIG. 13 is a cross-sectional view illustrating the vicinity of the pivot coupling portion; and

FIG. 14 is a cross-sectional view illustrating the vicinity of the pivot coupling portion.

### DETAILED DESCRIPTION

Hereinafter, an embodiment of a vehicle slide door device will be described with reference to the drawings.

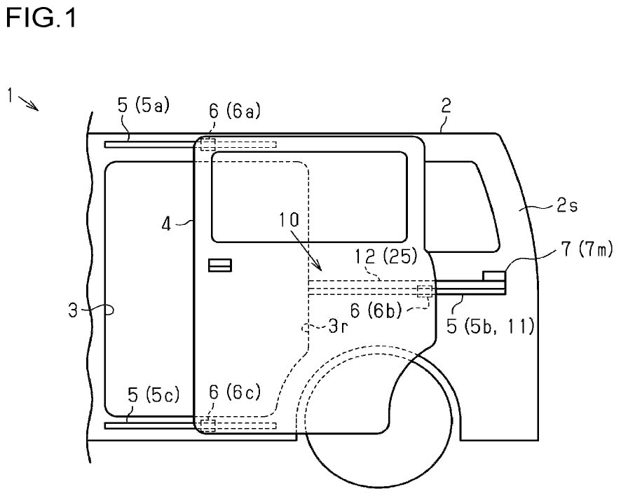

As illustrated in FIG. 1, a vehicle 1 according to the present embodiment includes a slide door 4 that opens and closes a door opening portion 3 provided in a side surface 2s of a vehicle body 2. Specifically, the vehicle 1 is provided with a plurality of guide rails 5a to 5c extending in a front-rear direction (a left-right direction in FIG. 1) and a plurality of guide roller units 6a to 6c coupled to the respective guide rails 5. That is, the slide door 4 according to the present embodiment is supported on the side surface 2s of the vehicle body 2 via the guide rails 5 and the guide roller units 6. The guide rails 5 and the guide roller units 6 are configured such that engagement positions of the guide roller units 6 with respect to the respective guide rails 5 can be moved along an extending direction of the guide rails 5. Accordingly, the slide door 4 according to the present embodiment is configured to move in a vehicle front-rear direction along the side surface 2s of the vehicle body 2.

That is, the slide door 4 according to the present embodiment is brought into a fully closed state where the door opening portion 3 is closed when the slide door 4 is moved to a vehicle front side (a left side in FIG. 1), and is brought into a fully opened state where an occupant of the vehicle 1 can get in and out through the door opening portion 3 when the slide door 4 is moved to a vehicle rear side (a right side in FIG. 1). The vehicle 1 according to the present embodiment is provided with a slide door device 10 that opens and closes the slide door 4 with a drive force generated by an actuator 7 using a motor 7m as a drive source.

### Guide Frame

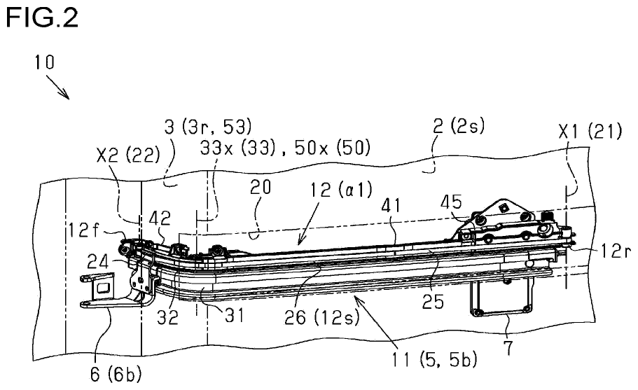

Specifically, as illustrated in FIGS. 1 and 2, the slide door device 10 according to the present embodiment includes a guide frame 12 provided in parallel to the guide rail 5b provided at a height in the vicinity of a belt line in the rear of the door opening portion 3, that is, a center rail 11. Specifically, in the vehicle 1 according to the present embodiment, the side surface 2s of the vehicle body 2 is provided with a groove-shaped accommodation recessed portion 20 extending in the vehicle front-rear direction. Further, the guide frame 12 according to the present embodiment and the center rail 11 are disposed in the accommodation recessed portion 20. Accordingly, the slide door device 10 according to the present embodiment is configured such that the center rail 11 and the guide frame 12 extend in an opening and closing operation direction of the slide door 4.

As illustrated in FIGS. 2 to 4, the slide door device 10 according to the present embodiment includes first and second pulleys 21 and 22 provided at both ends of the guide frame 12 in a longitudinal direction. Further, the slide door device 10 includes an annular drive belt 25 that has a coupling portion 24 to be coupled to the slide door 4 and is wound around the first and second pulleys 21 and 22. The slide door device 10 according to the present embodiment is configured such that the drive belt 25 is driven to rotate by the actuator 7 provided in the vicinity of a rear end portion 12r of the guide frame 12.

That is, in the slide door device 10 according to the present embodiment, the drive belt 25 wound around the first and second pulleys 21 and 22 is rotated with the drive force of the actuator 7, thereby moving the coupling portion 24 provided on the drive belt 25 in the vehicle front-rear direction. Further, in the slide door device 10 according to the present embodiment, the coupling portion 24 is fixed to the guide roller unit 6b engaged with the center rail 11. Accordingly, the slide door device 10 according to the present embodiment is configured to move the slide door 4 coupled to the drive belt 25 via the coupling portion 24 and the guide roller unit 6b in the vehicle front-rear direction, that is, perform an opening and closing operation.

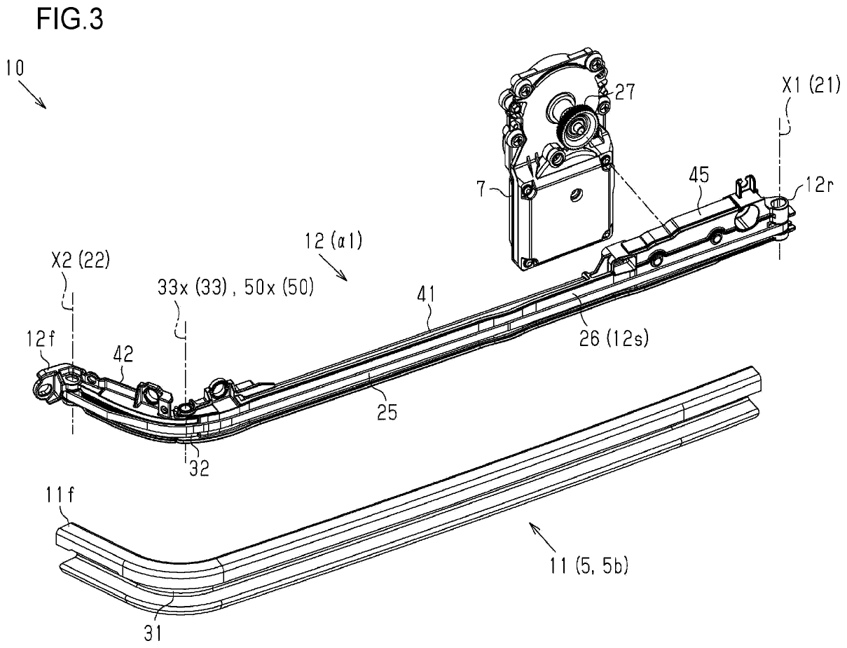

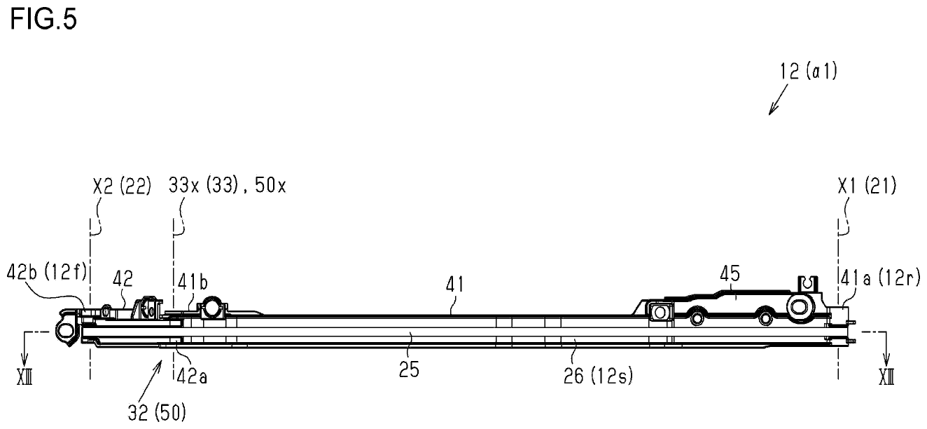

More specifically, as illustrated in FIGS. 3 to 5, the guide frame 12 according to the present embodiment has a rail-shaped outer shape including a side wall portion 12s facing outward in the vehicle width direction. The guide frame 12 is disposed within an annular shape of the drive belt 25 by winding the drive belt 25 around the first and second pulleys 21 and 22 provided at the both ends in the longitudinal direction of the guide frame 12 as described above. Accordingly, the guide frame 12 according to the present embodiment is configured to guide the drive belt 25 in a state where the side wall portion 12s faces an inner periphery of the drive belt 25.

That is, in the slide door device 10 according to the present embodiment, the guide frame 12 supports the first and second pulleys 21 and 22 at positions separated from each other. In the guide frame 12 according to the present embodiment, a guide path 26 for the drive belt 25 extending between support positions X1 and X2 of the first and second pulleys 21 and 22 is formed by the side wall portion 12s facing outward in the vehicle width direction.

The drive belt 25 according to the present embodiment is a toothed belt having teeth on the inner periphery. Further, the guide frame 12 according to the present embodiment supports, in the vicinity of the rear end portion 12r, a toothed pulley 27 that meshes with the teeth of the drive belt 25. The slide door device 10 according to the present embodiment is configured such that the drive force of the actuator 7 is transmitted to the drive belt 25 via the toothed pulley 27.

In the guide frame 12 according to the present embodiment, the toothed pulley 27 has a rotation shaft extending in a direction intersecting the longitudinal direction of the guide frame 12. Specifically, the toothed pulley 27 is supported by the guide frame 12 in a state where the rotation shaft is oriented in the vehicle width direction. Further, the guide frame 12 according to the present embodiment is provided with a pair of pressing pulleys 28, 28 that sandwich both sides of the toothed pulley 27 in the longitudinal direction of the guide frame 12. In the slide door device 10 according to the present embodiment, the drive belt 25 is wound around the pressing pulleys 28, 28 and the toothed pulley 27 alternately, so that the drive belt 25 in a twisted state can be stably driven to rotate.

### Corner Portion

As illustrated in FIGS. 2 and 3, in the vehicle 1 according to the present embodiment, the center rail 11 has a curved corner portion 31 in the vicinity of a front end portion 11f. That is, the corner portion 31 causes an extending direction of the center rail 11 to curve inward in the vehicle width direction toward the vehicle front side. Further, each of the guide rails 5 also has a corner portion (not illustrated) that causes the extending direction of the guide rail 5 to curve inward in the vehicle width direction toward the vehicle front side in a similar manner to the corner portion 31. Accordingly, the slide door device 10 according to the present embodiment is configured such that the slide door 4 supported on the side surface 2s of the vehicle body 2 via the guide rails 5 and the guide roller unit 6 can be opened and closed without interfering with the vehicle body 2.

More specifically, in the vehicle 1 according to the present embodiment, the center rail 11 is fixed to the vehicle body 2 in a state where the front end portion 11f is disposed at a rear edge portion 3r of the door opening portion 3 and the corner portion 31 is disposed at a boundary position with the side surface 2s of the vehicle body 2 located on a rear side (see FIG. 1). Accordingly, the vehicle 1 according to the present embodiment is configured such that the slide door 4 in the fully closed state is flush with the side surface 2s of the vehicle body 2.

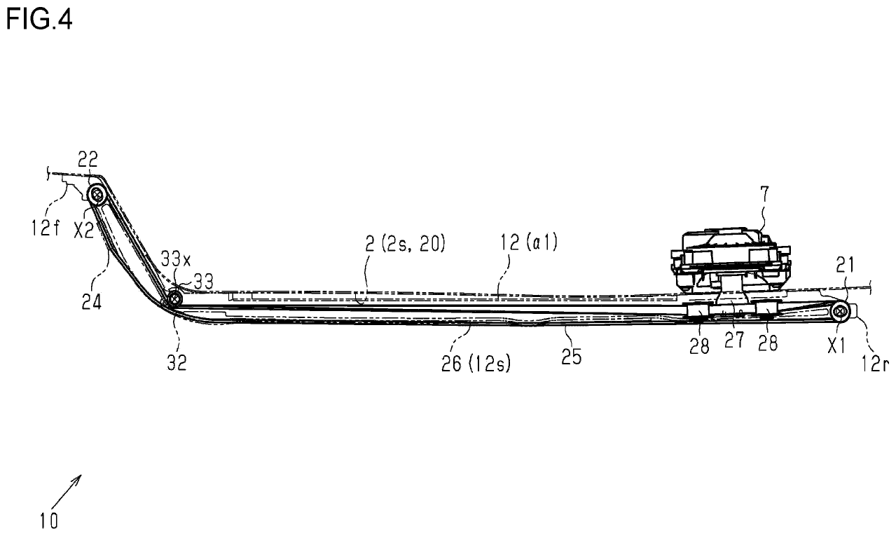

Further, as illustrated in FIGS. 2 to 4, in the slide door device 10 according to the present embodiment, the guide frame 12 also has a corner portion 32 extending in a curved manner in an intermediate position of the guide path 26 in the vicinity of a front end portion 12f in a similar manner to the corner portion 31 of the center rail 11. That is, the corner portion 32 also causes an extending direction of the guide frame 12 to curve inward in the vehicle width direction (upward in FIG. 4) toward the vehicle front side (a left side in FIG. 4). Accordingly, the slide door device 10 according to the present embodiment is configured such that the drive belt 25 including the coupling portion 24 to the slide door 4 is driven to rotate in a state where the drive belt 25 extends along an opening and closing movement trajectory of the slide door 4 that is moved in the vehicle front-rear direction while the drive belt 25 is displaced in the vehicle width direction.

As illustrated in FIG. 4, the guide frame 12 according to the present embodiment includes an intermediate pulley 33 provided at a position radially inside the corner portion 32. That is, the drive belt 25 according to the present embodiment is wound around the intermediate pulley 33 provided at an intermediate position of the guide path 26, so that the drive belt 25 is routed along the curved corner portion 32 even at a position on an inner side of the guide frame 12 in the vehicle width direction. Accordingly, the slide door device 10 according to the present embodiment is configured such that the drive belt 25 is driven to rotate in a state where the drive belt 25 extends along the side wall portion 12s constituting the guide path 26 over substantially an entire region in the longitudinal direction of the guide frame 12 including the corner portion 32.

### Pivoting Coupling Structure of Guide Frame

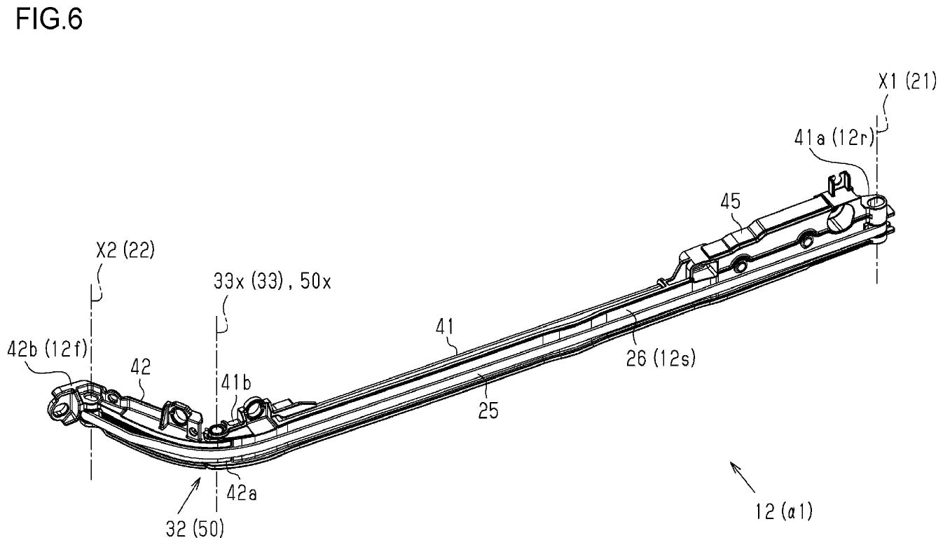

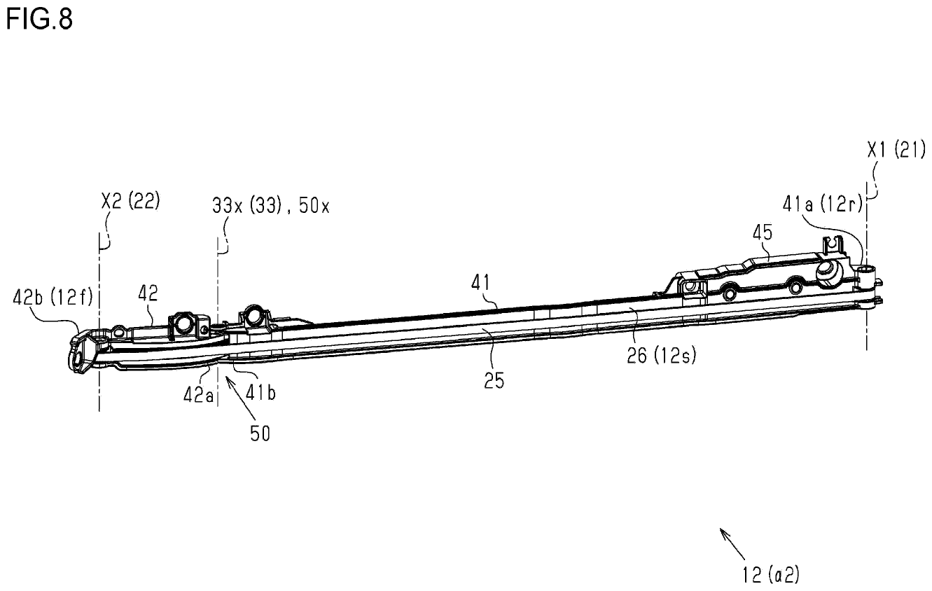

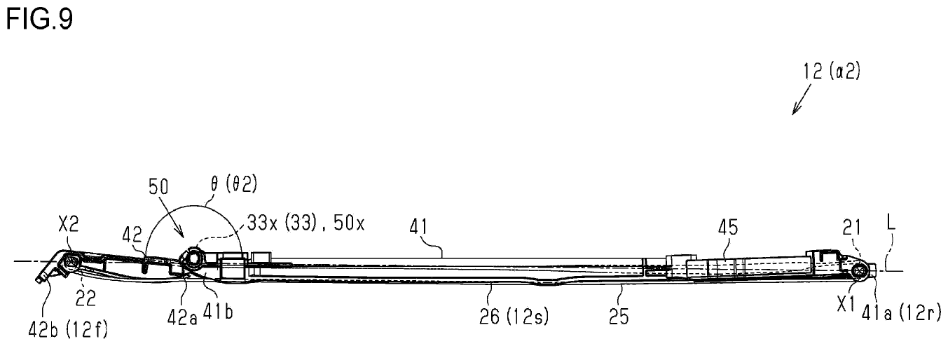

As illustrated in FIGS. 6 to 10, the guide frame 12 according to the present embodiment is configured such that a first frame member 41 that supports the first pulley 21 and a second frame member 42 that supports the second pulley 22 are coupled in a manner of being pivotable relative to each other.

Specifically, the first frame member 41 has a long rail shape extending substantially linearly. In the slide door device 10 according to the present embodiment, the first frame member 41 is made of a resin. The first frame member 41 supports the first pulley 21 on a first end portion 41a in a longitudinal direction of the first frame member 41. Further, the first frame member 41 has a fixing portion 45 for the actuator 7 in the vicinity of the first end portion 41a serving as the support position X1 of the first pulley 21. Accordingly, the first frame member 41 supports the pressing pulleys 28, 28 and the toothed pulley 27 of the drive belt 25 on the fixing portion 45 for the actuator 7.

The second frame member 42 has a long rail shape shorter than the first frame member 41. The second frame member 42 is also made of a resin. Further, the second frame member 42 supports the second pulley 22 on a second end portion 42b in a longitudinal direction of the second frame member 42. The guide frame 12 according to the present embodiment has a structure in which a first end portion 42a of the second frame member 42 in the longitudinal direction and a second end portion 41b of the first frame member 41 in the longitudinal direction are coupled in a manner of being pivotable around a coupling shaft 50x.

In other words, the guide frame 12 according to the present embodiment includes a pivot coupling portion 50 that couples the first and second frame members 41 and 42 in a manner in which the first and second frame members 41 and 42 can be pivoted around the coupling shaft 50x relative to each other. Further, the guide frame 12 according to the present embodiment is configured such that a support shaft 33x of the intermediate pulley 33 provided at an intermediate position of the guide path 26 serves as the coupling shaft 50x of the first and second frame members 41 and 42. Accordingly, the guide frame 12 according to the present embodiment can change a coupling state of the first and second frame members 41 and 42 according to relative pivoting between the first and second frame members 41 and 42.

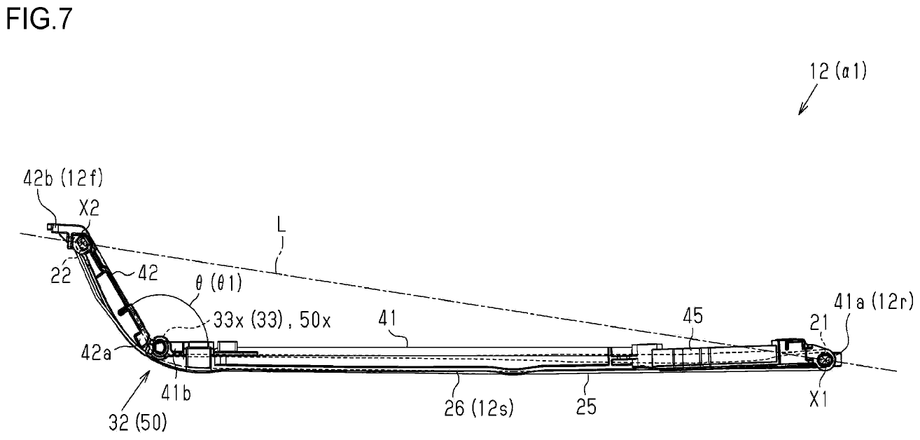

Specifically, as illustrated in FIGS. 6 and 7, the guide frame 12 according to the present embodiment has a first coupling state α1 where the first and second frame members 41 and 42 are disposed in a bent manner to have the corner portion 32 extending in a curved manner at an intermediate position of the guide path 26 as described above. In the first coupling state α1, the guide frame 12 according to the present embodiment is disposed in the accommodation recessed portion 20 provided in the side surface 2s of the vehicle body 2 in a manner of being parallel to the center rail 11 having the similar corner portion 31.

That is, as illustrated in FIG. 2, in the guide frame 12 according to the present embodiment, the first end portion 41a of the first frame member 41 having the support position X1 of the first pulley 21 is set as the rear end portion 12r, and the first frame member 41 is disposed in the accommodation recessed portion 20 facing outward in the vehicle width direction. In the guide frame 12, the second end portion 42b of the second frame member 42 having the support position X2 of the second pulley 22 is set as the front end portion 12f, and the second frame member 42 is disposed at the rear edge portion 3r of the door opening portion 3 facing the vehicle front side. Further, in this state, the corner portion 32 of the guide frame 12 is disposed at a boundary position between the rear edge portion 3r of the door opening portion 3 and the side surface 2s of the vehicle body 2 located on a rear side. Accordingly, the guide frame 12 according to the present embodiment is configured such that the guide path 26 for the drive belt 25 formed between the rear end portion 12r and the front end portion 12f extends in a manner of being curved inward in the vehicle width direction from the vehicle rear side toward the front side at the corner portion 32.

As illustrated in FIGS. 7 to 9, the guide frame 12 according to the present embodiment has a second coupling state α2 in which an angle θ formed between the first frame member 41 and the second frame member 42 is larger than that in the first coupling state α1 (θ1<θ2). Specifically, when the guide frame 12 according to the present embodiment is in the second coupling state α2, the first and second frame members 41 and 42 are linearly disposed along a direction of coupling the support positions X1 and X2 of the first and second pulleys 21 and 22. In other words, in the second coupling state α2, the first and second frame members 41 and 42 are disposed along a straight line L passing through the support positions X1 and X2 of the first and second pulleys 21 and 22. Further, in the slide door device 10 according to the present embodiment, the guide frame 12 is assembled to the accommodation recessed portion 20 provided in the vehicle body 2 in the second coupling state α2. The guide frame 12 according to the present embodiment is configured to be changed from the second coupling state α2 before assembly to the first coupling state α1 which is an actual use state by relatively pivoting the first and second frame members 41 and 42 after the guide frame 12 is assembled to the vehicle body 2.

### Interference Possibility During Assembly

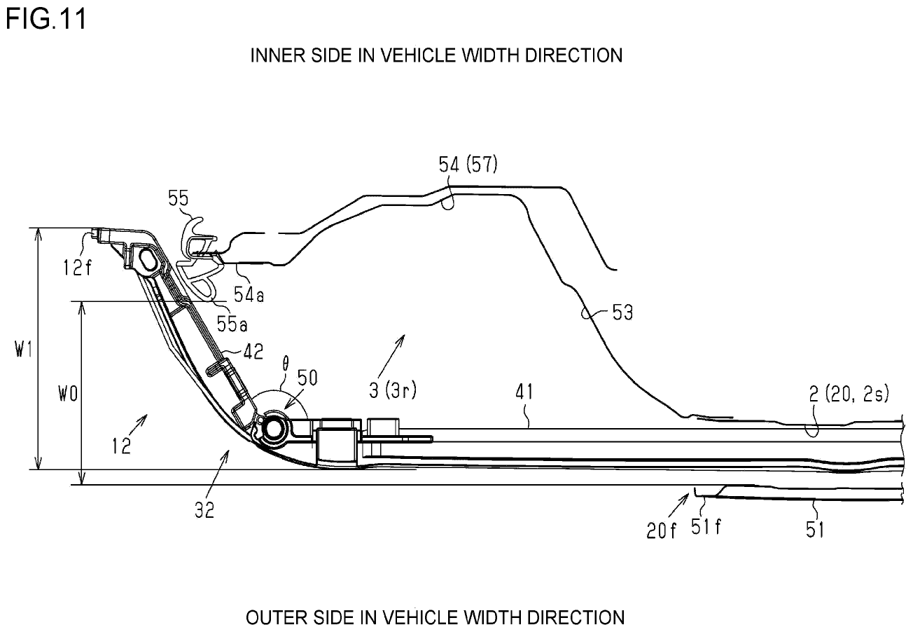

As illustrated in FIG. 11, it is assumed that a so-called “hidden structure” such as a cover member 51 that covers an outer side (a lower side in FIG. 11) of the accommodation recessed portion 20 in the vehicle width direction is provided for the accommodation recessed portion 20 provided in the side surface 2s of the vehicle body 2. In this case, for example, the guide frame 12 is assembled along an extending direction of the accommodation recessed portion 20 from the vehicle front side toward the rear side (from a left side to a right side in FIG. 11) via a front opening portion 20f of the accommodation recessed portion 20 formed by a front end portion 51f of the cover member 51. However, the guide frame 12 generally has the corner portion 32 whose extending direction is curved inward in the vehicle width direction (upward in FIG. 11) toward the vehicle front side as described above. Accordingly, when the guide frame 12 is assembled to the accommodation recessed portion 20 via the front opening portion 20f as described above, the front end portion 12f of the guide frame 12 positioned inward of a formation position of the accommodation recessed portion 20 in the vehicle width direction is likely to interfere with the vehicle body 2.

That is, the rear edge portion 3r of the door opening portion 3 where the front end portion 12f of the guide frame 12 is disposed has a rear wall surface 53 facing the vehicle front side where the front opening portion 20f of the accommodation recessed portion 20 is opened. The guide frame 12 is fixed to the vehicle body 2 in a state where a portion of the guide frame 12 on a side closer to the front end portion 12f than the corner portion 32 extending in a manner of being curved inward in the vehicle width direction toward the vehicle front side extends along the rear wall surface 53 (see FIG. 2).

However, the rear edge portion 3r of the door opening portion 3 generally has a side wall surface 54 that extends toward the vehicle front side and faces outward in the vehicle width direction in a manner in which the side wall surface 54 is continuous with the rear wall surface 53. Further, a weather strip 55 that liquid-tightly seals the rear edge portion 3r of the door opening portion 3 when the slide door 4 is in the fully closed state is provided at a tip end portion 54a of the side wall surface 54 in a manner of protruding outward in the vehicle width direction. Accordingly, when the guide frame 12 is assembled to the vehicle body 2 through the front opening portion 20f of the accommodation recessed portion 20 as described above, the front end portion 12f of the guide frame 12 may interfere with the weather strip 55.

Therefore, when the guide frame 12 is assembled to the accommodation recessed portion 20 in a state where an outer side in the vehicle width direction of the accommodation recessed portion 20 is covered by the cover member 51, a maximum width W1 in the vehicle width direction needs to be smaller than an assembly allowable width W0 in the vehicle width direction set in the vehicle body 2 (W1<W0).

That is, the maximum width W1 of the guide frame 12 in the vehicle width direction is a difference between a position on an outermost side in the vehicle width direction in a portion closer to the rear end portion 12r than the corner portion 32, that is, a linear portion disposed in the accommodation recessed portion 20, and the front end portion 12f located on an innermost side in the vehicle width direction. The assembly allowable width W0 of the vehicle body 2 in the vehicle width direction is a difference between the front end portion 51f of the cover member 51 where the front opening portion 20f of the accommodation recessed portion 20 is formed and a tip end 55a of the weather strip 55 protruding outward in the vehicle width direction at the rear edge portion 3r of the door opening portion 3. In particular, in the slide door device 10, when the slide door 4 is in the fully closed state, the guide roller unit 6 (see FIG. 1) is accommodated in the rear edge portion 3r of the door opening portion 3. Therefore, the side wall surface 54 is provided with a recessed portion 57 recessed inward in the vehicle width direction at a position close to the rear wall surface 53, and the tip end portion 54a provided with the weather strip 55 is often disposed at a position further outward in the vehicle width direction from the viewpoint of expanding a vehicle cabin space. Therefore, there is a problem that it is difficult to set a large value to the assembly allowable width W0 in the vehicle width direction on a vehicle body 2 side.

In view of this problem, the guide frame 12 according to the present embodiment has a configuration in which the first frame member 41 constituting the rear end portion 12r and the second frame member 42 constituting the front end portion 12f are coupled in a manner of being pivotable relative to each other. That is, the maximum width W1 in the vehicle width direction of the guide frame 12 according to the present embodiment is changed by changing the angle θ between the first frame member 41 and the second frame member 42. Specifically, the maximum width W1 in the vehicle width direction is reduced by setting the angle θ formed between the first frame member 41 and the second frame member 42 to be larger than that in the first coupling state α1 which is an actual use state where the corner portion 32 is provided at an intermediate position of the guide path 26. Accordingly, the guide frame 12 according to the present embodiment can be easily assembled, via the front opening portion 20f, to the accommodation recessed portion 20 of which the outer side in the vehicle width direction is covered by the “hidden structure” such as the cover member 51.

Further, when the guide frame 12 according to the present embodiment is in the second coupling state α2, the first and second frame members 41 and 42 are linearly arranged around the pivot coupling portion 50. Accordingly, the guide frame 12 according to the present embodiment can be assembled along the extending direction of the accommodation recessed portion 20 from the vehicle rear side toward the front side via, for example, a rear opening portion of the accommodation recessed portion 20 formed by a rear end portion of the cover member 51 (not illustrated).

### Coupling State Maintaining Mechanism

The guide frame 12 according to the present embodiment is provided with a coupling state maintaining mechanism 60 that maintains the first and second frame members 41 and 42 in the second coupling state α2 by restricting the relative pivoting between the first and second frame members 41 and 42. Accordingly, in the slide door device 10 according to the present embodiment, a coupling state of the first and second frame members 41 and 42 can be stably maintained in the guide frame 12 before assembly.

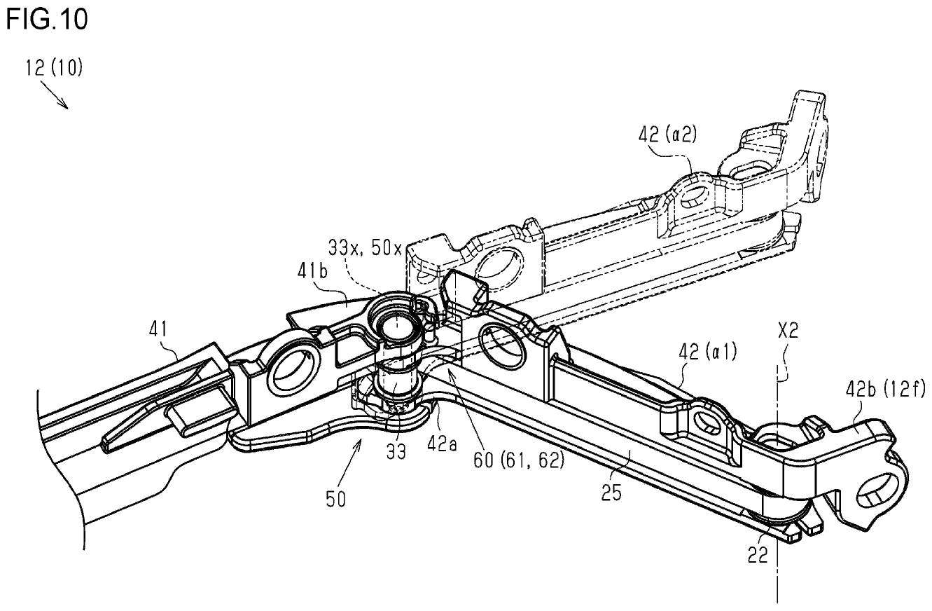

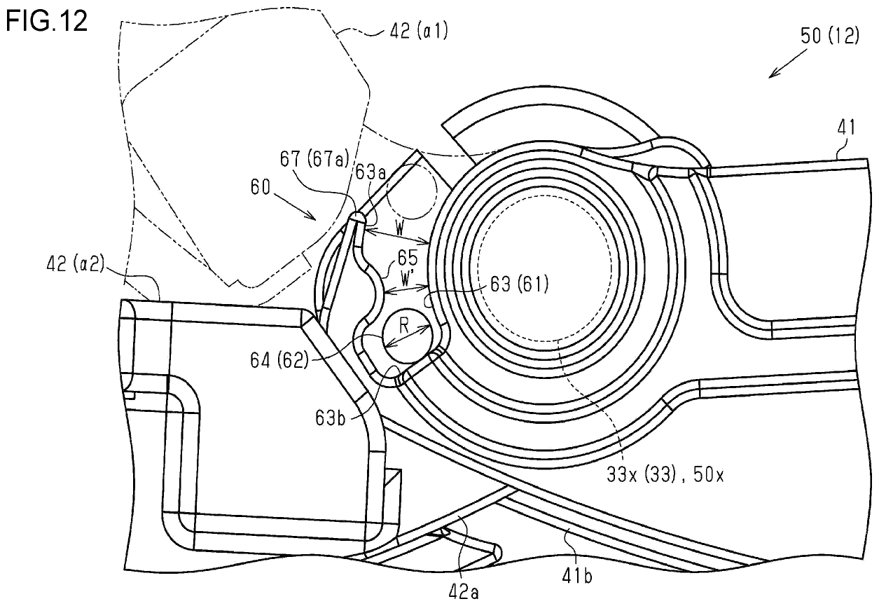

Specifically, as illustrated in FIGS. 10 and 12, the guide frame 12 according to the present embodiment includes a first engagement portion 61 provided in the first frame member 41 and a second engagement portion 62 provided in the second frame member 42. In the guide frame 12 according to the present embodiment, the first engagement portion 61 is configured as an arc-shaped engagement groove 63 extending in a circumferential direction in the vicinity of the coupling shaft 50x of the first and second frame members 41 and 42. The second engagement portion 62 is configured as an engagement protrusion portion 64 that has a short axial outer shape protruding in an axial direction in the vicinity of the same coupling shaft 50x of the first and second frame members 41 and 42. Further, in the guide frame 12 according to the present embodiment, the engagement protrusion portion 64 and the engagement groove 63 are engaged and disengaged according to the relative pivoting between the first and second frame members 41 and 42. The coupling state maintaining mechanism 60 according to the present embodiment restricts the relative pivoting between the first and second frame members 41 and 42 with an engagement force of the engagement protrusion portion 64 and the engagement groove 63.

Specifically, in the guide frame 12 according to the present embodiment, the engagement groove 63 has, at one end in the circumferential direction, an opening portion 63a through which the engagement protrusion portion 64 can enter and come out of the groove shape according to the relative pivoting between the first and second frame members 41 and 42. The engagement groove 63 according to the present embodiment is provided with a locking protrusion portion 65 that protrudes into the groove shape extending in an arc shape in a state where a groove width W of the engagement groove 63 is narrowed. The locking protrusion portion 65 according to the present embodiment has a semicircular protruding shape when viewed from an axial direction of the coupling shaft 50x (when viewed from a front side of a paper surface in FIG. 12). Further, when the guide frame 12 according to the present embodiment is in the second coupling state α2 where the first and second frame members 41 and 42 are linearly arranged, the engagement protrusion portion 64 that entered the engagement groove 63 is apparently disposed closer to a back end portion 63b of the engagement groove 63 than the locking protrusion portion 65. In this state, the guide frame 12 according to the present embodiment is such that the relative pivoting between the first and second frame members 41 and 42 in a direction in which the engagement protrusion portion 64 moves away from the engagement groove 63 is restricted by locking the engagement protrusion portion 64 with the locking protrusion portion 65.

More specifically, in the guide frame 12 according to the present embodiment, when the first and second frame members 41 and 42 are pivoted relative to each other in a direction in which the coupling state is changed from a bent arrangement to a linear arrangement, the engagement protrusion portion 64 apparently enters the engagement groove 63 through the opening portion 63a. In FIG. 12, when the second frame member 42 is pivoted in a counterclockwise direction in FIG. 12 about the coupling shaft 50x relative to the first frame member 41, the engagement protrusion portion 64 enters the engagement groove 63. Further, the engagement protrusion portion 64 that entered the engagement groove 63 moves to the vicinity of the back end portion 63b of the engagement groove 63 in such a manner that the engagement protrusion portion 64 rides over the locking protrusion portion 65 provided in the engagement groove 63. In this state, the guide frame 12 according to the present embodiment is maintained in the second coupling state α2 where the first and second frame members 41 and 42 are linearly arranged.

Specifically, a radially outer side portion (a left side wall portion in FIG. 12) of the engagement groove 63 extending around the coupling shaft 50x of the first and second frame members 41 and 42 is configured as an engagement claw 67 serving as a tip end 67a which is a formation position of the opening portion 63a. Further, the locking protrusion portion 65 is provided in a manner of protruding radially inward (rightward in FIG. 12) from the engagement claw 67. The guide frame 12 according to the present embodiment is configured such that the engagement claw 67 is bent radially outward with an operation force for relatively pivoting the first and second frame members 41 and 42, thereby enabling the engagement protrusion portion 64 moving in the engagement groove 63 to move beyond the locking protrusion portion 65.

That is, in the guide frame 12 according to the present embodiment, the engagement groove 63 has a groove width W larger than a diameter R of the engagement protrusion portion 64 having a substantially circular cross section (R<W). Further, a groove width W of the engagement groove 63 at a portion where the locking protrusion portion 65 is provided is smaller than the diameter R of the engagement protrusion portion 64 (R>W″). The guide frame 12 according to the present embodiment is configured such that the engagement protrusion portion 64 can move in the engagement groove 63 in a manner in which the groove width W of the portion where the locking protrusion portion 65 is provided is widened by bending the engagement claw 67 of the engagement groove 63 as described above.

In the slide door device 10 according to the present embodiment, the guide frame 12 before assembly is maintained in the second coupling state α2 by using a function of the coupling state maintaining mechanism 60. Further, after the guide frame 12 is assembled to the vehicle body 2, the first and second frame members 41 and 42 are pivoted relative to each other against the engagement force of the engagement protrusion portion 64 and the engagement groove 63, specifically, a force with which the locking protrusion portion 65 locks the engagement protrusion portion 64 in the engagement groove 63. Accordingly, the slide door device 10 according to the present embodiment can easily change the coupling state from the second coupling state α2 to the first coupling state α1 after the guide frame 12 is assembled to the vehicle body 2.

### Tension Applying Member

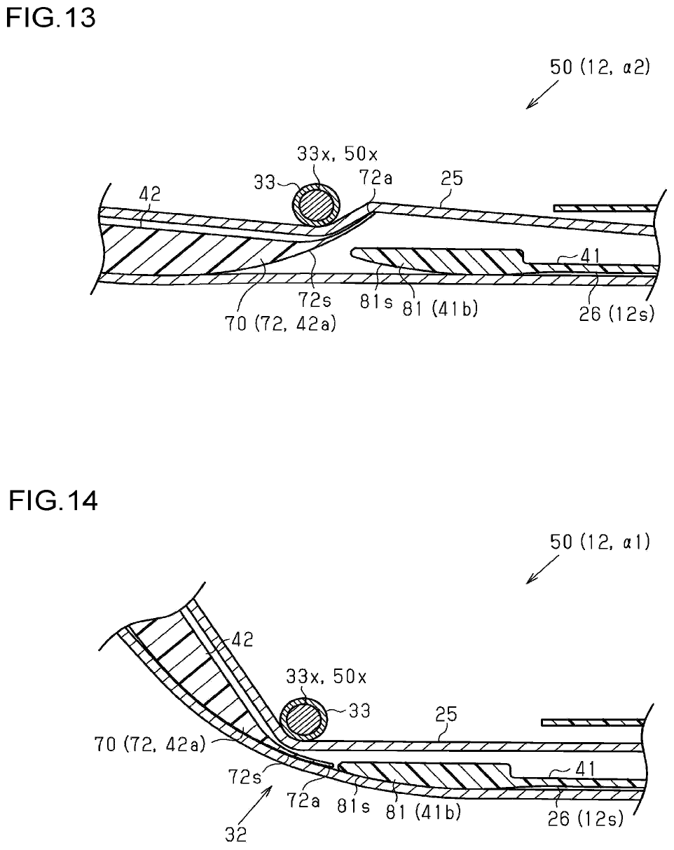

As illustrated in FIG. 13, the guide frame 12 according to the present embodiment includes a tension applying member 70 that applies tension to the drive belt 25 by pressing the drive belt 25 in the second coupling state α2 where the first and second frame members 41 and 42 are linearly arranged.

More specifically, as illustrated in FIG. 14, when the guide frame 12 according to the present embodiment is in the first coupling state α1, a first end portion 42a side of the second frame member 42 is configured as a curved guide member 72 disposed in the corner portion 32. That is, at the corner portion 32 where the coupling shaft 50x of the first and second frame members 41 and 42 is disposed on a radially inner side, the curved guide member 72 has a curved guide surface 72s where the guide path 26 for the drive belt 25 is formed along a curved shape of the guide surface 72s. Further, in the guide frame 12 according to the present embodiment, the curved guide member 72 provided integrally with the first end portion 42a of the second frame member 42 has an extending end portion 72a on one side of the guide surface 72s for guiding the drive belt 25. The guide frame 12 according to the present embodiment is configured such that the extending end portion 72a of the curved guide member 72 extends beyond the coupling shaft 50x of the pivot coupling portion 50 to a first frame member 41 side (a right side in FIG. 14).

As illustrated in FIG. 13, when the guide frame 12 according to the present embodiment is in the second coupling state α2, the extending end portion 72a of the curved guide member 72 comes into contact with the drive belt 25 according to the relative pivoting between the first and second frame members 41 and 42. Specifically, in the curved guide member 72 according to the present embodiment, in the vicinity of the intermediate pulley 33, the extending end portion 72a protruding toward the first frame member 41 side comes into contact with the drive belt 25 spanned between the intermediate pulley 33 and the first pulley 21 from an inner side of the annular shape of the drive belt 25. Further, in the guide frame 12 according to the present embodiment, the extending end portion 72a of the curved guide member 72 presses the drive belt 25 so as to deform the annular shape of the drive belt 25 in a manner of strengthening winding around the intermediate pulley 33. Accordingly, even when the guide frame 12 according to the present embodiment is in the first coupling state α1, tension is applied to the drive belt 25 by the curved guide member 72.

Further, as illustrated in FIG. 14, when the guide frame 12 according to the present embodiment shifts from the second coupling state α2 to the first coupling state α1, the extending end portion 72a of the curved guide member 72 comes out of contact with the drive belt 25 according to the relative pivoting between the first and second frame members 41 and 42. Accordingly, the slide door device 10 according to the present embodiment is configured such that the drive belt 25 can be driven to rotate smoothly in a state where the drive belt 25 extends along the guide path 26 formed in the guide frame 12 shifted to the first coupling state α1.

In the guide frame 12 according to the present embodiment, the second end portion 41b of the first frame member 41 is also configured as a curved guide member 81 having a curved guide surface 81s. Further, in the first coupling state α1, the guide surface 81s of the curved guide member 81 provided integrally with the first frame member 41 and the guide surface 72s of the curved guide member 72 provided integrally with the second frame member 42 are disposed in a manner of being coupled to each other. Accordingly, the guide frame 12 according to the present embodiment is configured such that the curved guide path 26 for the drive belt 25 extending along a curved shape of the corner portion 32 is formed in a manner of straddling the first and second frame members 41 and 42.

### Function

The guide frame 12 according to the present embodiment is assembled into the accommodation recessed portion 20 provided in the vehicle body 2 in the second coupling state α2 where the first and second frame members 41 and 42 are linearly arranged. Further, after the guide frame 12 is assembled to the accommodation recessed portion 20, the first and second frame members 41 and 42 are pivoted relative to each other, thereby changing the guide frame 12 to the first coupling state α1 where the first and second frame members 41 and 42 are disposed in a bent manner. Accordingly, the guide frame 12 according to the present embodiment is fixed to the vehicle body 2 in a state where the corner portion 32 extending in a curved manner is provided at an intermediate position of the guide path 26 formed in the guide frame 12.

With such a configuration, the guide frame 12 can be assembled, not only from the outer side in the vehicle width direction but also from the longitudinal direction of the guide frame 12, to the accommodation recessed portion 20 extending in the vehicle front-rear direction by maintaining the guide frame 12 in the second coupling state α2.

For example, in a state where the so-called “hidden structure” such as the cover member 51 is already provided in the accommodation recessed portion 20 provided in the vehicle body 2, the guide frame 12 in the second coupling state α2 is assembled from the opening portion on the vehicle front side or the vehicle rear side. Even in such a case, since the first and second frame members 41 and 42 are linearly arranged, a portion serving as the corner portion 32 in an actual use state, that is, the first coupling state α1 is less likely to interfere with the “hidden structure” and the vehicle body 2. Accordingly, in the guide frame 12 according to the present embodiment, the ease of assembly to the vehicle body 2 is improved.

Next, effects according to the present embodiment will be described.

(1) The slide door device 10 includes the drive belt 25 that drives the slide door 4 of the vehicle 1 to be opened or closed, and the first and second pulleys 21 and 22 around which the drive belt 25 is wound. The slide door device 10 includes the guide frame 12 that supports the first and second pulleys 21 and 22 at positions separated from each other and has the guide path 26 for the drive belt 25 extending between the support positions X1 and X2 of the first and second pulleys 21 and 22. Further, the guide frame 12 includes the first frame member 41 that supports the first pulley 21 and the second frame member 42 that supports the second pulley 22. The guide frame 12 includes the pivot coupling portion 50 that is provided between the first frame member 41 and the second frame member 42 and couples the first and second frame members 41 and 42 in such a manner that the first frame member 41 and the second frame member 42 are pivotable relative to each other.

According to the above configuration, after the guide frame 12 is assembled to the vehicle body 2 in a state where the angle θ formed between the first frame member 41 and the second frame member 42 is widened, the angle θ formed between the first frame member 41 and the second frame member 42 is narrowed. That is, after the guide frame 12 is assembled to the vehicle body 2 in a state where the maximum width W1 in the vehicle width direction is narrowed, the guide frame 12 can be fixed to the vehicle body 2 in a more curved state by widening the maximum width W1 in the vehicle width direction. Therefore, for example, even in a case where the guide frame 12 is assembled to the accommodation recessed portion 20 that is already covered by a “hidden structure” such as the cover member 51, the guide frame 12 is less likely to interfere with the accommodation recessed portion 20. Accordingly, the ease of assembly to the vehicle body 2 can be improved.

(2) The slide door device 10 includes, at an intermediate position of the guide path 26, the intermediate pulley 33 around which the drive belt 25 is wound. The pivot coupling portion 50 is configured such that the support shaft 33x of the intermediate pulley 33 serves as the coupling shaft 50x of the first and second frame members 41 and 42.

According to the above configuration, the pivot coupling portion 50 can be formed with a simple configuration. Further, the corner portion 32 where the extending direction of the guide frame 12 is curved can be formed at an appropriate position by arranging the first and second frame members 41 and 42 in a manner of being bent around the pivot coupling portion 50. Further, when the guide frame 12 is assembled to the vehicle body 2, the first and second frame members 41 and 42 including a portion serving as the corner portion 32 can be linearly arranged by widening the angle θ formed between the first frame member 41 and the second frame member 42. Accordingly, the ease of assembly to the vehicle body 2 can be improved.

(3) The guide frame 12 has the first coupling state α1 where the first and second frame members 41 and 42 are disposed to have the corner portion 32 extending in a curved manner at an intermediate position of the guide path 26 according to the relative pivoting between the first and second frame members 41 and 42. The guide frame 12 has the second coupling state α2 where the angle θ formed between the first frame member 41 and the second frame member 42 is larger than that in the first coupling state α1. The guide frame 12 includes the coupling state maintaining mechanism 60 that maintains the first and second frame members 41 and 42 in the second coupling state α2 by restricting the relative pivoting between the first and second frame members 41 and 42.

According to the above configuration, when the guide frame 12 is assembled to the vehicle body 2, the first and second frame members 41 and 42 can be stably maintained in the second coupling state α2 where the angle θ formed between the first frame member 41 and the second frame member 42 is widened. Accordingly, the guide frame 12 can be more easily assembled to the accommodation recessed portion 20 provided in the vehicle body 2. In addition, there is an advantage that a storage property and transportability are improved by maintaining the state where the first and second frame members 41 and 42 are linearly arranged.

(4) The guide frame 12 includes the tension applying member 70 that applies tension to the drive belt 25 by pressing the drive belt 25 in the second coupling state α2. When the guide frame 12 is in the first coupling state α1, the tension applying member 70 comes out of contact with the drive belt 25 according to the relative pivoting between the first and second frame members 41 and 42.

According to the above configuration, even in the second coupling state α2 where the angle θ formed between the first frame member 41 and the second frame member 42 is widened, the drive belt 25 is less likely to be loosened. Accordingly, the guide frame 12 can be more easily assembled to the accommodation recessed portion 20 provided in the vehicle body 2. Further, a possibility that the loosened drive belt 25 comes into contact with a foreign matter can be reduced. Accordingly, high reliability can be ensured. In the first coupling state α1 which is an actual use state, the tension applying member 70 does not interfere with the drive belt 25. Accordingly, the drive belt 25 can be driven smoothly.

(5) In the coupling state maintaining mechanism 60, the first engagement portion 61 provided in the first frame member 41 and the second engagement portion 62 provided in the second frame member 42 are engaged and disengaged according to the relative pivoting between the first and second frame members 41 and 42.

According to the above configuration, the guide frame 12 can be maintained in the second coupling state α2 with a simple configuration, and the coupling state maintaining mechanism 60 that can release the maintaining of the second coupling state α2 can be formed.

(6) The guide frame 12 includes the curved guide member 72 disposed in the corner portion 32, and the curved guide member 72 serves as the tension applying member 70. The extending end portion 72a of the curved guide member 72 comes into and out of contact with the drive belt 25 according to the relative pivoting between the first and second frame members 41 and 42.

According to the above configuration, the curved guide member 72 can form the guide path 26 for the drive belt 25 along the curved shape of the corner portion 32. It is possible to switch between applying tension to the drive belt 25 and releasing the application of tension with a simple configuration by utilizing a displacement of the extending end portion 72a caused by the relative pivoting between the first and second frame members 41 and 42.

The embodiment described above can be modified as follows. The embodiment described above and the following modifications can be combined with one another without technical contradiction.

In the embodiment described above, when the guide frame 12 is in the second coupling state α2, the first and second frame members 41 and 42 are linearly disposed along a direction of coupling the support positions X1 and X2 of the first and second pulleys 21 and 22. However, the embodiment disclosed here is not limited thereto, and the angle θ formed between the first frame member 41 and the second frame member 42 may be changed freely in the second coupling state α2. When the guide frame 12 is in the second coupling state α2, the maximum width W1 in the vehicle width direction may be narrower than that in the first coupling state α1. The angle θ formed between the first frame member 41 and the second frame member 42 at which the coupling state maintaining mechanism 60 and the tension applying member 70 effectively function may be changed freely.

In the embodiment described above, the pivot coupling portion 50 is configured such that the support shaft 33x of the intermediate pulley 33 provided at a position in an intermediate portion of the guide path 26 serves as the coupling shaft 50x of the first and second frame members 41 and 42. However, the embodiment disclosed here is not limited thereto, and the configuration of the pivot coupling portion 50 may be changed freely. The coupling shaft 50x may be provided other than the support shaft 33x of the intermediate pulley 33. The embodiment disclosed here may be applied to a configuration without the intermediate pulley 33.

In the embodiment described above, the first engagement portion 61 provided in the first frame member 41 is configured as the engagement groove 63 extending in the circumferential direction at a radially outer side of the coupling shaft 50x of the pivot coupling portion 50. The second engagement portion 62 provided in the second frame member 42 is configured as the engagement protrusion portion 64 having a short axial outer shape. The coupling state maintaining mechanism 60 can maintain the guide frame 12 in the second coupling state α2 and release the maintaining by engaging and disengaging the engagement protrusion portion 64 and the engagement groove 63 according to the relative pivoting between the first and second frame members 41 and 42.

However, the embodiment disclosed here is not limited thereto, and the configuration of the coupling state maintaining mechanism 60 may be changed freely. For example, the first engagement portion 61 may be the engagement protrusion portion 64, and the second engagement portion 62 may be the engagement groove 63. The first and second engagement portions 61 and 62 may both have a protruding shape configured to be engageable and disengageable according to the relative pivoting between the first and second frame members 41 and 42.

The coupling state maintaining mechanism 60 may have a configuration other than the above-described configuration in which the first and second engagement portions 61 and 62 are engaged and disengaged. For example, when the first and second frame members 41 and 42 are in the second coupling state α2, a pair of through holes communicating with each other are provided in the first and second frame members 41 and 42. Further, the relative pivoting between the first and second frame members 41 and 42 is restricted by inserting a shaft-shaped member such as a so-called “anti-rotation pin” in a state of straddling the through holes. Accordingly, the guide frame 12 may be maintained in the second coupling state α2.

Further, the coupling state maintaining mechanism 60 may restrict the relative pivoting between the first and second frame members 41 and 42 by engaging a pivoting lever provided on one of the first and second frame members 41 and 42 with a shaft portion provided on the other one of the first and second frame members 41 and 42. For example, in the second coupling state α2, the first and second frame members 41 and 42 may be fixed by screwing or the like so that the first and second frame members 41 and 42 cannot pivot relative to each other.

In the embodiment described above, the first end portion 42a side of the second frame member 42 is configured as the curved guide member 72 disposed in the corner portion 32 in the first coupling state α1. In the first coupling state α1, the curved guide member 72 serves as the tension applying member 70, and the extending end portion 72a presses the drive belt 25.

However, the embodiment disclosed here is not limited thereto, and the configuration of the tension applying member 70 may be changed freely. For example, the curved guide member 81 provided in the first frame member 41 may function as the tension applying member 70. The tension applying member 70 may be not the curved guide members 72 and 81. That is, the tension applying member 70 may not necessarily be a component of the guide path 26. Further, the tension applying member 70 may be separate from the first and second frame members 41 and 42. The tension applying member 70 may be changed freely as long as the tension applying member 70 can apply tension to the drive belt 25 by pressing the drive belt 25 in the first coupling state α1.

In the embodiment described above, the guide frame 12 is provided in parallel to the center rail 11 extending in the rear of the door opening portion 3. However, the embodiment disclosed here is not limited thereto, and for example, the guide frame 12 may be parallel to an upper rail provided above the door opening portion 3 or a lower rail provided below the door opening portion 3.

In the embodiment described above, the actuator 7 is provided in the vicinity of the rear end portion 12r of the guide frame 12. However, the embodiment disclosed here is not limited thereto, and the arrangement of the actuator 7 may be changed freely. The configuration of the actuator 7 and a driving method of the drive belt 25 may also be changed freely.

Although the slide door 4 is a so-called rear opening slide door that opens toward the vehicle rear side in the embodiment described above, the embodiment disclosed here may be applied to a so-called front opening configuration.

Next, technical ideas that can be understood from the embodiment and the modifications described above will be described.

(A) According to a first aspect, there is provided a vehicle slide door device including a drive belt configured to drive a slide door of a vehicle to open and close, first and second pulleys around which the drive belt is wound, and a guide frame that supports the first and second pulleys at positions separated from each other and has a guide path for the drive belt extending between support positions of the first and second pulleys. The guide frame includes a first frame member that supports the first pulley, a second frame member that supports the second pulley, and a pivot coupling portion that is provided between the first frame member and the second frame member and couples the first and second frame members in such a manner that the first frame member and the second frame member are pivotable relative to each other.

According to the above configuration, after the guide frame is assembled to a vehicle body in a state where an angle formed between the first frame member and the second frame member is widened, the angle formed between the first frame member and the second frame member is narrowed. That is, after the guide frame is assembled to the vehicle body in a state where a maximum width in a vehicle width direction is narrowed, the guide frame can be fixed to the vehicle body in a more curved state by widening the maximum width in the vehicle width direction. Therefore, for example, even when the guide frame is assembled to an accommodation recessed portion that is already covered by a “hidden structure” such as a cover member, the guide frame is less likely to interfere with the accommodation recessed portion. Accordingly, the ease of assembly to the vehicle body can be improved.

(B) According to a second aspect, the vehicle slide door device according to the first aspect, further includes an intermediate pulley that is provided at an intermediate position of the guide path and around which the drive belt is wound. The pivot coupling portion is configured such that a support shaft of the intermediate pulley serves as a coupling shaft of the first and second frame members.

(C) According to a third aspect, in the vehicle slide door device according to the first aspect or the second aspect, the guide frame has, according to relative pivoting between the first and second frame members, a first coupling state where the first and second frame members are disposed to have a corner portion extending in a curved manner at an intermediate position of the guide path, and a second coupling state where an angle formed between the first frame member and the second frame member is larger than that in the first coupling state, and the guide frame includes a coupling state maintaining mechanism configured to maintain the guide frame in the second coupling state by restricting the relative pivoting between the first and second frame members.

(D) According to a fourth aspect, in the vehicle slide door device according to any one of the first to third aspects, the guide frame has, according to relative pivoting between the first and second frame members, a first coupling state where the first and second frame members are disposed to have a corner portion extending in a curved manner at an intermediate position of the guide path, and a second coupling state where an angle formed between the first frame member and the second frame member is larger than that in the first coupling state, and the guide frame includes a tension applying member configured to apply tension to the drive belt by pressing the drive belt in the second coupling state.

(E) According to a fifth aspect, in the vehicle slide door device according to the third aspect, the coupling state maintaining mechanism is configured such that a first engagement portion provided in the first frame member and a second engagement portion provided in the second frame member are engaged and disengaged according to the relative pivoting between the first and second frame members.

(F) According to a sixth aspect, in the vehicle slide door device according to the fourth aspect, when the guide frame is in the first coupling state, the tension applying member comes out of contact with the drive belt according to the relative pivoting between the first and second frame members.

(G) According to a seventh aspect, in the vehicle slide door device according to the sixth aspect, the guide frame includes a curved guide member disposed in the corner portion, the curved guide member serves as the tension applying member, and the curved guide member has an extending end portion that comes into and out of contact with the drive belt according to the relative pivoting between the first and second frame members.

According to this disclosure, the ease of assembly to the vehicle body can be improved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle slide door device comprising:
a drive belt configured to drive a slide door of a vehicle to open and close;
first and second pulleys around which the drive belt is wound; and
a guide frame that supports the first and second pulleys at positions separated from each other and has a guide path for the drive belt extending between support positions of the first and second pulleys, wherein
the guide frame includes
a first frame member that supports the first pulley,
a second frame member that supports the second pulley, and
a pivot coupling portion that is provided between the first frame member and the second frame member and couples the first and second frame members in such a manner that the first frame member and the second frame member are pivotable relative to each other.

2. The vehicle slide door device according to claim 1, further comprising:
an intermediate pulley that is provided at an intermediate position of the guide path and around which the drive belt is wound, wherein
the pivot coupling portion is configured such that a support shaft of the intermediate pulley serves as a coupling shaft of the first and second frame members.

3. The vehicle slide door device according to claim 1, wherein
the guide frame has,
according to relative pivoting between the first and second frame members,
a first coupling state where the first and second frame members are disposed to have a corner portion extending in a curved manner at an intermediate position of the guide path, and
a second coupling state where an angle formed between the first frame member and the second frame member is larger than that in the first coupling state, and
the guide frame includes a coupling state maintaining mechanism configured to maintain the guide frame in the second coupling state by restricting the relative pivoting between the first and second frame members.

4. The vehicle slide door device according to claim 1, wherein
the guide frame has,
according to relative pivoting between the first and second frame members,
a first coupling state where the first and second frame members are disposed to have a corner portion extending in a curved manner at an intermediate position of the guide path, and
a second coupling state where an angle formed between the first frame member and the second frame member is larger than that in the first coupling state, and
the guide frame includes a tension applying member configured to apply tension to the drive belt by pressing the drive belt in the second coupling state.

5. The vehicle slide door device according to claim 3, wherein
the coupling state maintaining mechanism is configured such that a first engagement portion provided in the first frame member and a second engagement portion provided in the second frame member are engaged and disengaged according to the relative pivoting between the first and second frame members.

6. The vehicle slide door device according to claim 4, wherein
when the guide frame is in the first coupling state, the tension applying member comes out of contact with the drive belt according to the relative pivoting between the first and second frame members.

7. The vehicle slide door device according to claim 4, wherein
the guide frame includes a curved guide member disposed in the corner portion, and the curved guide member serves as the tension applying member, and
the curved guide member has an extending end portion that comes into and out of contact with the drive belt according to the relative pivoting between the first and second frame members.

8. The vehicle slide door device according to claim 2, wherein
the guide frame has,
according to relative pivoting between the first and second frame members,
a first coupling state where the first and second frame members are disposed to have a corner portion extending in a curved manner at an intermediate position of the guide path, and
a second coupling state where an angle formed between the first frame member and the second frame member is larger than that in the first coupling state, and
the guide frame includes a coupling state maintaining mechanism configured to maintain the guide frame in the second coupling state by restricting the relative pivoting between the first and second frame members.

9. The vehicle slide door device according to claim 8, wherein
the coupling state maintaining mechanism is configured such that a first engagement portion provided in the first frame member and a second engagement portion provided in the second frame member are engaged and disengaged according to the relative pivoting between the first and second frame members.

10. The vehicle slide door device according to claim 2, wherein
the guide frame has,
according to relative pivoting between the first and second frame members,
a first coupling state where the first and second frame members are disposed to have a corner portion extending in a curved manner at an intermediate position of the guide path, and
a second coupling state where an angle formed between the first frame member and the second frame member is larger than that in the first coupling state, and
the guide frame includes a tension applying member configured to apply tension to the drive belt by pressing the drive belt in the second coupling state.

11. The vehicle slide door device according to claim 10, wherein
when the guide frame is in the first coupling state, the tension applying member comes out of contact with the drive belt according to the relative pivoting between the first and second frame members.

12. The vehicle slide door device according to claim 10, wherein
the guide frame includes a curved guide member disposed in the corner portion, and the curved guide member serves as the tension applying member, and
the curved guide member has an extending end portion that comes into and out of contact with the drive belt according to the relative pivoting between the first and second frame members.
